(19) United States
(12) Patent Application Publication
(10) Pub. No.: US 2012/0201340 A1
(43) Pub. Date: Aug. 9, 2012

(54) System and Method for Integration of Wet and Dry Nuclear Fuel Storage

(76) Inventors: Charles W. Pennington, Alpharetta, GA (US); Tom Danner, Norcross, GA (US); George C. Carver, Norcross, GA (US); Craig Seaman, Roswell, GA (US)

(21) Appl. No.: 13/395,712

(22) PCT Filed: Sep. 15, 2010
(86) PCT No.: PCT/US10/48878

§ 371 Date: Apr. 26, 2012

Related U.S. Application Data
(60) Provisional application No. 61/242,480, filed on Sep. 15, 2009.

(51) Int. Cl. G21C 19/07; G21C 19/32; G21C 19/00

(52) U.S. Cl. 376/261

(57) ABSTRACT

Systems and methods of loading and/or removing spent nuclear fuel from a spent nuclear fuel pool are disclosed. A spent fuel basket compatible with a dry storage and/or transport system is disposed in a spent nuclear fuel pool. At least one spent fuel assembly is loaded in one of a plurality of chambers associated with the spent fuel basket. The spent fuel basket is inserted into a spent fuel canister. The spent fuel canister is loaded into a transfer cask. The spent fuel canister is then transferred from the transfer cask to a storage cask or a transport cask, which can be sealed and stored on-site or in an off-site storage facility.

### CROSS-REFERENCE TO RELATED APPLICATION

This application claims the benefit of U.S. Provisional Patent Application No. 61/242,480, filed Sep. 15, 2009, which is hereby incorporated herein by reference in its entirety.

### BACKGROUND

Spent nuclear fuel can be stored in reservoirs of water referred to as a spent nuclear fuel pool. Spent nuclear fuel assemblies can be immersed or stored in the spent nuclear fuel pool until such time as appropriate thermal and/or radioactivity conditions have been met, at which the assemblies can be transferred into transport and/or dry storage systems for off-site storage. Spent nuclear fuel assemblies are often comprised of an elongated assembly with a rectangular or other shaped cross section. As a spent nuclear fuel pool reaches capacity, it can be desirable to remove spent nuclear fuel assemblies and transfer one or more assemblies to on-site or off-site storage. On-site or off-site storage of spent nuclear fuel can involve placing spent nuclear fuel assemblies in a storage cask and/or transport cask that is hardened against accidents that may occur during storage or transport.

### SUMMARY

Included are systems and methods for storing spent nuclear fuel. At least one embodiment of a method includes a method for storing spent nuclear fuel, comprising the steps of disposing a spent fuel basket in a spent nuclear fuel pool; loading at least one spent nuclear fuel assembly in at least one chamber of a spent fuel basket, the spent fuel basket having a plurality of chambers, each of the chambers adapted to receive a spent nuclear fuel assembly; loading the spent fuel basket in a spent fuel canister; and loading the spent fuel canister into a storage cask or a transport cask.

Also included are embodiments of a system. At least one embodiment of a system includes a spent nuclear fuel pool; a superstructure in the spent nuclear fuel pool, the superstructure having at least one supporting structure; and at least one spent fuel basket, the at least one spent fuel basket having a plurality of chambers, each of the chambers adapted to store a spent nuclear fuel assembly, the at least one spent fuel basket further configured to be received by at least one of a spent fuel canister and a transfer cask; wherein the at least one supporting structure of the superstructure is configured to accept the at least one spent fuel basket.

At least one embodiment of a system also includes means for immersing a plurality of spent nuclear fuel assembles; means for containing the plurality of spent nuclear fuel assemblies; means for securing the containing means in the immersing means; means for lifting the containing means; and means for inserting the containing means in a transport or storage means.

Other systems, methods, features, and advantages of this disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a spent nuclear fuel pool according to various embodiments of the present disclosure.

FIG. 2 is a drawing of a spent fuel canister that can accept a spent fuel basket from the spent nuclear fuel pool of FIG. 1.

FIG. 3 is a drawing of an alternative configuration of a spent nuclear fuel pool according to various embodiments of the present disclosure.

FIG. 4 is a drawing of a spent fuel canister that can accept a spent fuel basket from the spent nuclear fuel pool of FIG. 3.

FIG. 5 is a drawing of yet another alternative configuration of a spent nuclear fuel pool according to various embodiment of the present disclosure.

FIGS. 6A and 6B are drawings of a spent fuel basket from the spent nuclear fuel pool of FIG. 5.

FIGS. 7A and 7B are drawings of a spent fuel canister configured to accept a spent fuel basket from the spent nuclear fuel pool of FIG. 5.

FIGS. 8A and 8B are drawings of insertion of a spent fuel basket into the spent fuel canister of FIGS. 7A and 7B.

FIGS. 9A and 9B of a sealed spent fuel canister.

FIGS. 10A and 10B are drawings of a spent fuel transfer cask.

FIGS. 11A and 11B are drawings of insertion of a spent fuel canister into the spent fuel transfer cask of FIGS. 10A and 10B.

FIG. 12 is a flowchart illustrating a method according to an embodiment of the disclosure.

### DETAILED DESCRIPTION

In the following discussion, a general description of systems and methods according to various embodiments of the present disclosure is provided, followed by a discussion of the operation of the same. Embodiments of the present disclosure relate to spent nuclear fuel storage and transport systems. More specifically, disclosed herein are novel approaches to the implementation of spent nuclear fuel pools that can increase the efficiency of storage and/or removal of spent fuel from such a pool.

A spent nuclear fuel assembly, in some embodiments, can comprise an elongated assembly with a cross section that is often square or rectangular, but that can have a cross sectional shape of any kind. In prior art systems, each spent fuel assembly can be stored in a metal tube having a cross section and length corresponding to the size of the spent fuel assembly stored therein. More than one of the above-described tubes can be stored in close proximity in the spent nuclear fuel pool, often being mechanically joined together as a rack system to form a rectangular and/or square array in a spent nuclear fuel pool dependent on the geometry of a particular pool in which they are disposed. A rack in a spent nuclear fuel pool comprises various hardware components installed in the spent nuclear fuel pool to contain the various tubes containing spent fuel assembles. A spent nuclear fuel pool can have numerous racks immersed therein until the spent nuclear fuel pool does not have the capacity to accept additional spent nuclear fuel assembles or thermal and other conditions of the spent nuclear fuel assembles make it appropriate for them to be removed from the pool and stored in dry storage systems. The rack structures are self-supporting and may be free-standing, although some spent fuel pools may be designed to anchor racks to the pool through the use of vertical or lateral mechanical means.

As a prior art spent nuclear fuel pool reaches capacity, the fuel assemblies in a spent nuclear fuel pool can be removed from the pool and placed in a dry storage system so that additional spent fuel assemblies that are used by a reactor can be immersed in the spent nuclear fuel pool until the spent fuel reaches appropriate thermal and/or radioactive levels such that it is appropriate for them to be removed therefrom.

Dry storage systems (termed “dry storage”) can be employed so that nuclear power plants can discharge and store spent nuclear fuel external to a spent nuclear fuel pool, thereby permitting continued operation of the power plants as the pool reaches its capacity and the plants are operated for extended periods of time with appropriate regulatory approvals. In one embodiment, a dry storage system can include concrete storage casks in which metal canisters having canister final closure lids that are welded closed or sealed with mechanical methods at the power plants following spent fuel loading are inserted. A storage cask or transport cask serves as an enclosure or overpack structure that provides mechanical protection, heat removal features, and radiation shielding for the inner metal canister that encloses the spent fuel. Such a cask can be designed for spent fuel storage as well as spent fuel transportation. Accordingly, transportable dry storage systems can be employed to facilitate storage of spent nuclear fuel at or near a site of a nuclear power facility as well as the ability to transport spent fuel in a transport cask to an ultimate storage or disposal facility following a period of at-reactor dry storage without having to remove the spent fuel from the dry storage system.

In most dry storage systems used with wet storage (e.g. immersion in a spent nuclear fuel pool), the spent nuclear fuel at the time of discharge from a reactor emanates high levels of heat and radiation due to radioactive decay, levels that are higher than dry storage systems can efficiently and economically store. Therefore, discharged spent fuel must spend some amount of time in the spent nuclear fuel pool until the radioactive decay and associated heat has reached levels sufficiently low so that dry storage technology can be used. This period of time for required storage in the spent fuel pool can be 3 to 10 years or more.

In dry storage systems, an inner structure is often employed to hold and geometrically position the spent fuel that is placed either into the metal cask or into the metal canister. In embodiments of the present disclosure, this inner structure, referred to herein as a spent fuel basket, can include various metal tubes or other structures that are mechanically joined together in close proximity as a unitized structure, the number and array thereof being determined by the desired size and weight of a metal canister and transport cask in which it is disposed.

Accordingly, in prior art spent nuclear fuel pools and dry storage systems, the design, size and geometry of storage racks in a spent nuclear fuel pool and baskets for a dry storage system are often incompatible due to differing design requirements. Dry storage systems, which can include a basket, canister and transfer cask so that the spent fuel stored therein can be transferred to a storage cask or a transport cask, are often configured to withstand more impact intensive and thermally threatening accident conditions than a prior art spent fuel pool rack designed for immersion with spent nuclear fuel assembles in a pool. Additionally, dry storage systems are often more structurally robust and more conservative with respect to analysis of a full range of structural, thermal, shielding, and/or criticality design basis events. Prior art racks for a spent nuclear fuel pool are often designed to withstand drop events onto the rack systems and of seismic events and the resulting excitation of the racks that could cause very modest rack impacts with each other and with the pool floor and walls.

Accordingly, the transferring of spent nuclear fuel assemblies into a dry storage system spent fuel basket can be a labor intensive and expensive process, which can require a great deal of handling of the assembles, increasing the risk of radiation exposure and/or accident. In prior art systems, each fuel assembly must be removed from a prior art wet storage rack in a spent nuclear fuel pool and inserted into a corresponding chamber in a dry storage basket. In other words, each of the assemblies may be required to be handled, one by one, until a dry storage basket is filled, at which time the basket is inserted into a canister, the basket-in-canister then inserted into a transfer cask, which is finally transferred to the storage overpack (e.g., a concrete dry storage cask) of the dry storage system. Additionally, in such a prior art system, upon closing, decontamination and/or decommissioning of a spent nuclear fuel pool, the wet storage rack hardware components installed in a spent nuclear fuel pool to provide structural support must undergo various decommissioning and decontamination procedures.

Accordingly, embodiments of the present disclosure are directed to spent fuel storage systems and methods that provide a more efficient loading and/or unloading of spent nuclear fuel assemblies in a spent nuclear fuel pool. Additionally, embodiments of this disclosure can reduce the labor required to remove a spent fuel assembly from a spent nuclear fuel pool and to store the spent nuclear fuel assembly in a dry storage and/or transport system. As a result, embodiments of the disclosure can reduce risk to personnel by reducing the number of times a spent nuclear fuel assembly must be handled individually when the assembly is eventually placed within a dry storage system. Furthermore, embodiments of this disclosure permit the use of baskets for both wet and dry storage, reducing the hardware (e.g., a full pool of wet storage racks) that must be purchased at the startup of the reactor and permitting only incremental purchases of baskets over time as pool storage demands require. Additionally embodiments of this disclosure can reduce decontamination and decommissioning costs by reducing the amount of hardware remaining in a spent fuel pool that must be disposed of at the end of life of a spent nuclear fuel pool and/or when various components must be replaced.

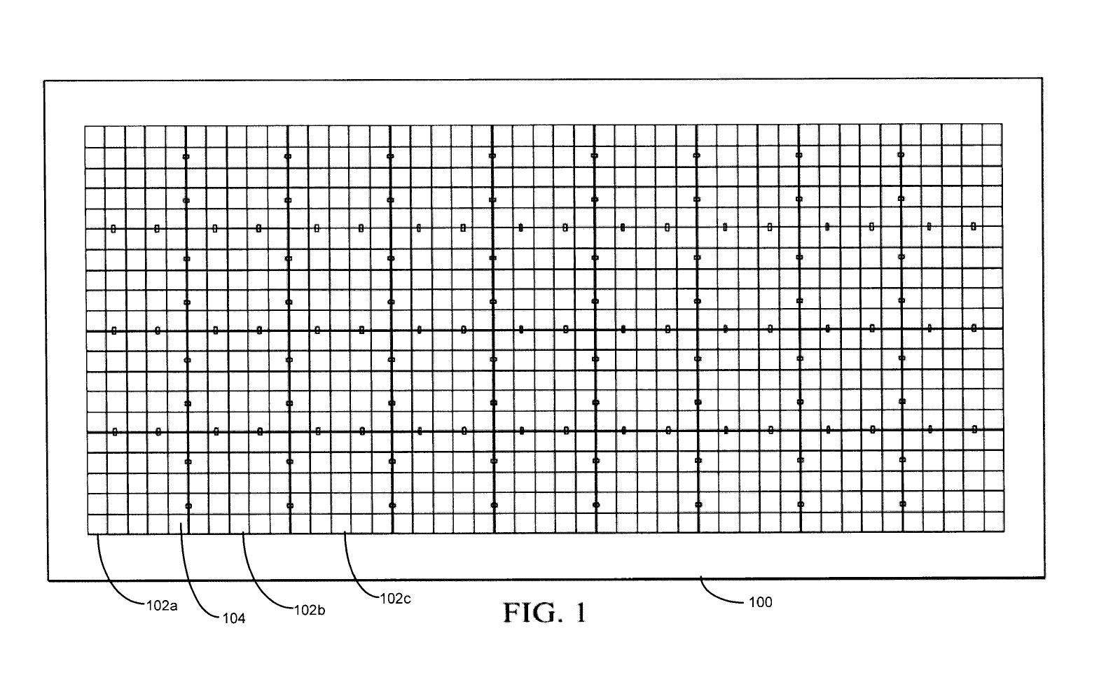

Therefore, reference is now made to FIG. 1, which depicts a spent nuclear fuel pool 100 according to one embodiment of the present disclosure. FIG. 1 illustrates one configuration of a spent fuel pool according to the disclosure. It should be appreciated that various alternative configurations can be employed that are consistent with the disclosure. The depicted spent nuclear fuel pool 100 includes at least one spent fuel basket 102a, 102b, 102c that can be placed within the spent nuclear fuel pool 100. Each of the spent fuel baskets 102 that can be configured with at least one chamber 104 in which a spent nuclear fuel assembly and/or a tube containing a spent nuclear fuel assembly can be inserted.

In contrast to a prior art spent nuclear fuel pool, the depicted spent nuclear fuel pool is equipped with the capability to accept spent fuel baskets 102 that are configured to be compatible with a dry storage system. Accordingly, the spent nuclear fuel pool 100 is configured with a superstructure to support the spent fuel baskets and any additional equipment associated therewith. As described above, a spent fuel basket compatible with a dry storage system is often engineered to handle accident conditions that may occur during transport and dry storage. Consequently, a spent fuel basket 102 of the depicted embodiment may be engineered with additional support and/or protective structures relative to a prior art tube containing a spent fuel assembly in a prior art spent nuclear fuel pool. The spent fuel baskets 102 can also be mechanically coupled to one another by the in-pool superstructure to provide additional stability within the spent nuclear fuel pool 100 for wet storage design basis conditions and for handling of the spent fuel baskets.

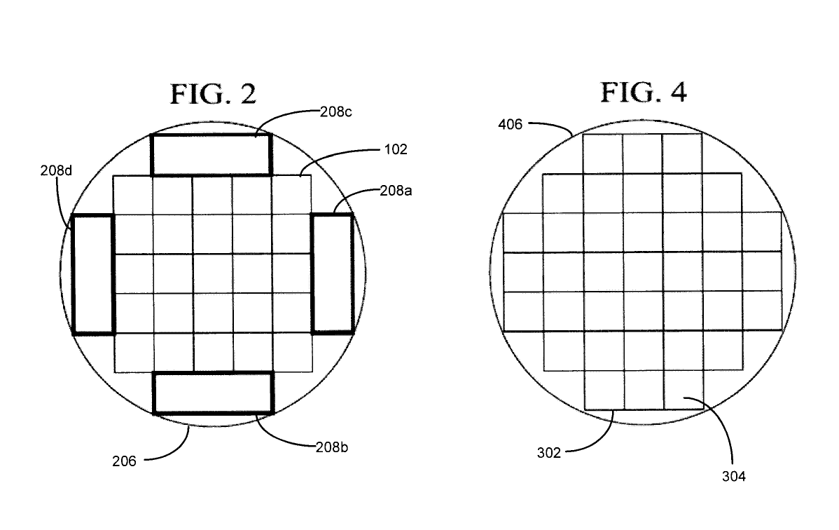

Reference is now made to FIG. 2, which depicts a spent fuel canister 206 that is compatible with a dry storage system that can include a transport cask. The spent fuel canister is configured to accept a spent fuel basket 102 employed in the spent nuclear fuel pool 100 shown in FIG. 1. The spent fuel canister is configured to accept a spent fuel basket 102 from the embodiment shown in FIG. 1. Accordingly, the spent fuel canister 206 is configured with various internal supporting structures 208a, 208b, 208c, 208d. The internal supporting structures 208 are provided for additional spent fuel storage locations and structural support for the spent fuel basket 102 within the spent fuel canister 206 and to restrict movement of the spent fuel basket 102 during transport and/or storage consistent with a dry storage system.

Therefore, in one embodiment, the spent fuel basket 102 can be lifted with a lifting crane securing the basket 102 via one or more lifting lug and inserted into the spent fuel canister 206. In contrast to prior art spent nuclear fuel pools, each spent nuclear fuel assembly and/or metal tube containing a fuel assembly does not have to be individually lifted and inserted into a basket within a canister in the transfer cask for movement to a dry storage system when the assembly is designated for removal from the pool, thereby reducing the labor cost as well as exposure and accident risks associated therewith.

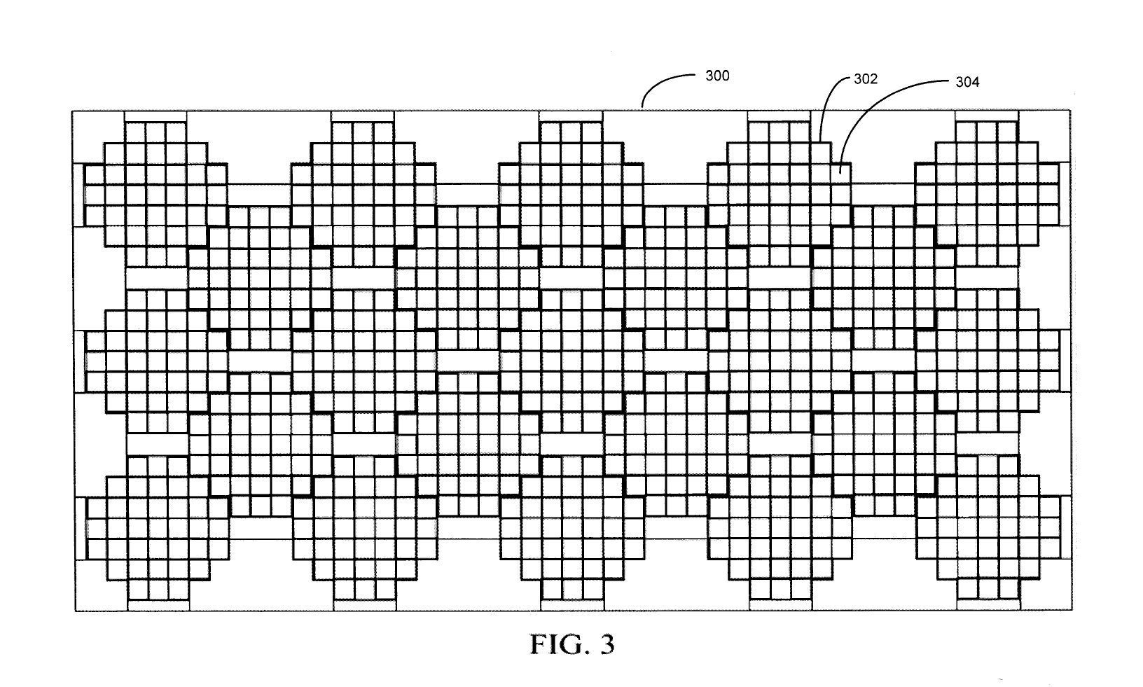

Reference is now made to FIG. 3, which depicts an alternative embodiment of a spent nuclear fuel pool 300 according to the disclosure. The depicted spent nuclear fuel pool 300 is configured with spent fuel baskets 302 compatible with a dry storage system that can include a transport cask. The depicted spent nuclear fuel pool 300 is in an alternative arrangement relative to the pool 100 shown in FIG. 1. The depicted spent fuel baskets 302 are configured with an alternative geometry so that additional spent fuel assemblies can be inserted in the various chambers 304 of each of the spent fuel baskets 302. It should be appreciated that the wet storage efficiency of the spent nuclear fuel pool 100 depicted in FIG. 1 is greater than that of the spent nuclear fuel pool 300 shown in FIG. 3.

As in the previous example illustrated in FIGS. 1 and 2, the various spent fuel baskets 302 can be mechanically coupled to one another to increase structural stability within the spent nuclear fuel pool 300. Additionally, an appropriate superstructure can be erected within the spent nuclear fuel pool 300 to provide structural support for the spent fuel baskets 302 that are compatible with a dry storage system and the additional weight that may accompany these baskets compared to prior art rack based wet storage configurations. In the depicted example, the spent fuel baskets 302 can store additional spent fuel assemblies and fit more efficiently in a spent fuel canister relative to the configuration shown in FIG. 1.

Accordingly, reference is now made to FIG. 4, which depicts the spent fuel baskets 302 of FIG. 3 disposed in a spent fuel canister 406 as described above. As also described above, the alternative spent fuel baskets 302 employed in the spent nuclear fuel pool 300 of FIG. 3 can more efficiently store spent fuel assemblies in a plurality of chambers 304 of the spent fuel basket 302 relative to the example shown in FIGS. 1 and 2.

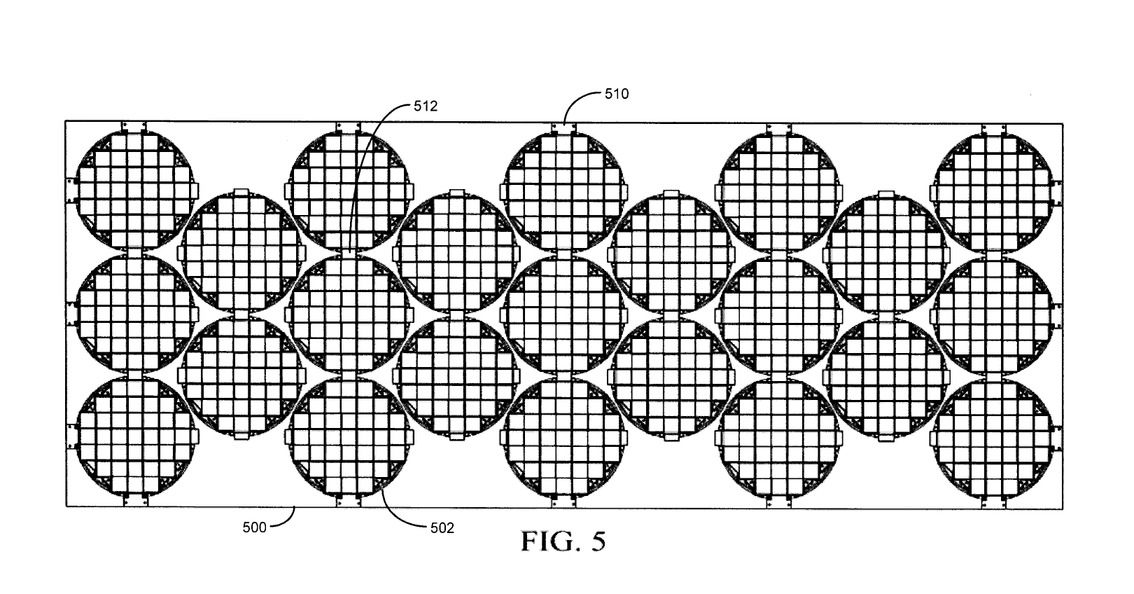

Reference is now made to FIG. 5, which depicts another alternative spent nuclear fuel pool 500 according to an embodiment of the present disclosure. The depicted spent nuclear fuel pool 500 illustrates spent fuel baskets 502 disposed therein. FIG. 5 additionally illustrates pool mechanical couplings 510 that can secure the spent fuel baskets 502 to the spent nuclear fuel pool 500 to provide structural stability to the spent fuel baskets 502 when they are disposed therein. FIG. 5 also illustrates basket mechanical couplings 512 that can couple adjacent spent fuel baskets to one another to provide structural stability to the spent fuel baskets 502 when they are disposed therein. The spent nuclear fuel pool 500 can also include a superstructure to support the weight of the spent fuel baskets 502 disposed within the pool 500 as well as provide structural stability in light of seismic events that may occur to impart forces on the spent nuclear fuel pool 500.

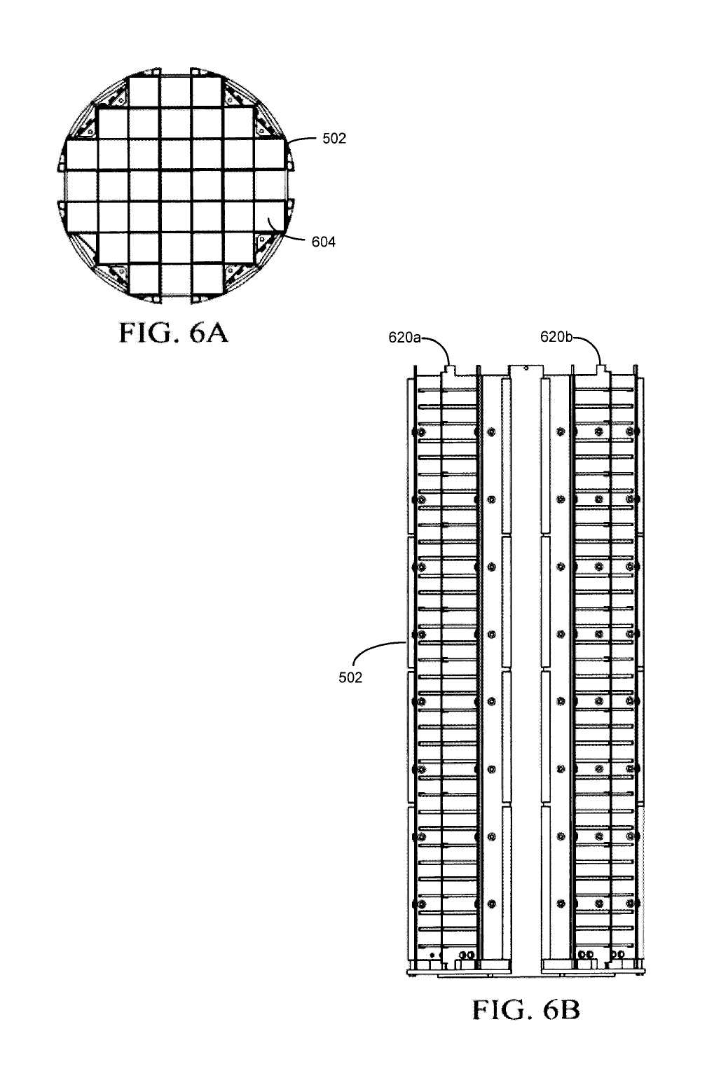

Accordingly, reference is now made to FIGS. 6A-11B, which illustrate a method according to various embodiments of the disclosure. More specifically, FIGS. 6A-11B illustrate storing spent fuel assemblies in a spent fuel basket associated with a dry storage system. FIGS. 6A-11B then illustrate placing the spent fuel basket in a spent fuel canister and then a transfer cask associated with the dry storage system. Finally, a transfer cask associated with the dry storage system can be employed to transfer a basket-in-canister to a storage cask associated with a dry storage system. FIG. 6A illustrates a top plan view of a spent fuel basket 502 according to various embodiments of the disclosure. The spent fuel basket 502 includes a plurality of chambers 604 in which spent nuclear fuel assembles and/or tubes containing spent nuclear fuel assemblies can be stored in a spent nuclear fuel pool. Additionally, FIG. 6B illustrates a side view of the spent fuel basket 502. FIG. 6B illustrates lifting lugs 620a, 620b, that can be used to lift a spent fuel basket 502 from a spent nuclear fuel pool and insert the spent fuel basket 502 in a spent fuel canister. Additionally, when a spent fuel basket 502 is removed from the spent nuclear fuel pool in which it is disposed, an empty spent fuel basket 502 can be disposed in the spent nuclear fuel pool in its place, in which additional spent nuclear fuel assemblies can be placed in wet storage in the spent nuclear fuel pool.

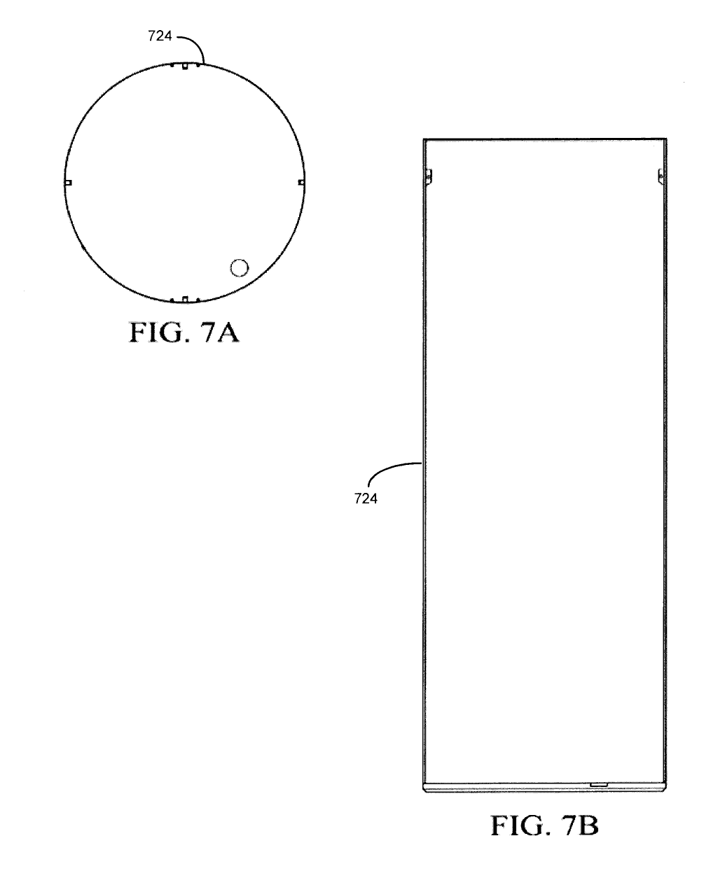

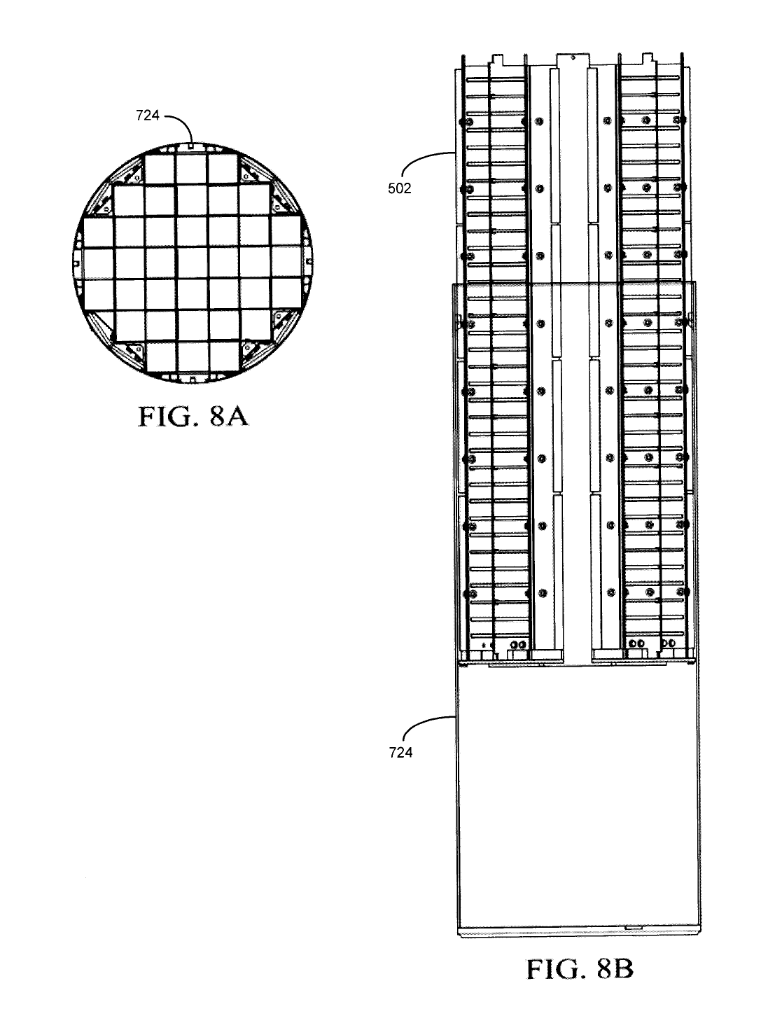

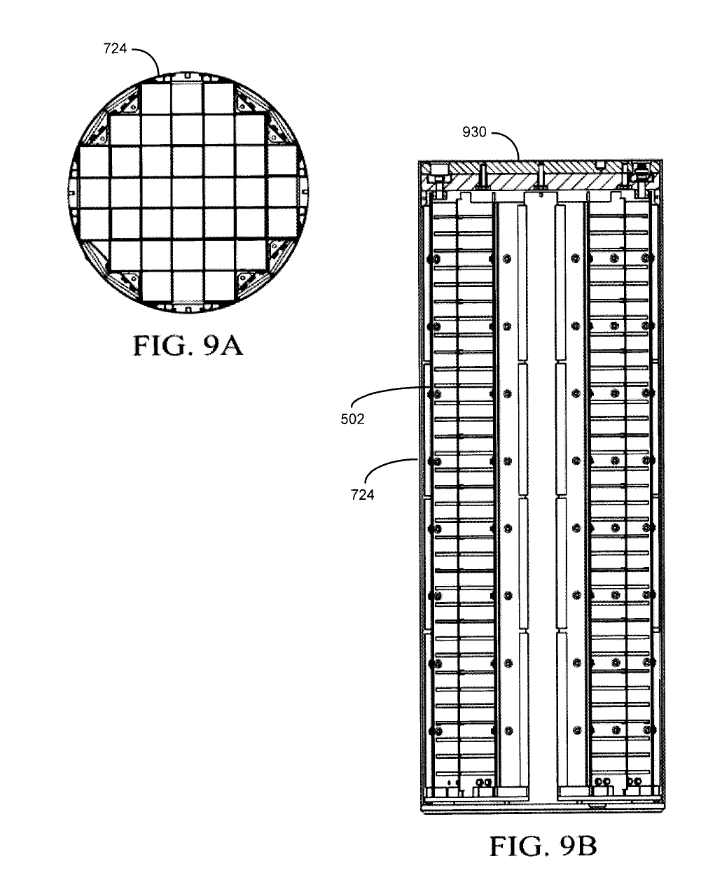

Therefore, reference is now made to FIGS. 7A and 7B, which illustrate a spent fuel canister 724, which can be appropriately sized to accept a spent fuel basket. In many cases, the spent fuel canister 724 can be constructed of metal, or other materials that provide protection as well as radiation shielding for the spent nuclear fuel assemblies stored in a spent fuel basket 502. FIGS. 8A and 8B illustrate the step of inserting a spent fuel basket 502 removed from a spent nuclear fuel pool and containing spent nuclear fuel assemblies into a spent fuel canister 724 according to various embodiments of the disclosure. In some embodiments, the step of inserting a spent fuel basket 502 can be completed in a transfer area of a spent nuclear fuel pool. In other words, the spent fuel canister 724 can be placed in the transfer area, and then spent fuel basket 502 lowered via a lifting crane into the spent fuel canister 724 in the transfer area. FIGS. 9A and 9B illustrate the spent fuel canister 724, which can be sealed with a canister closure lid 930 after the spent fuel basket 502 is inserted in the canister.

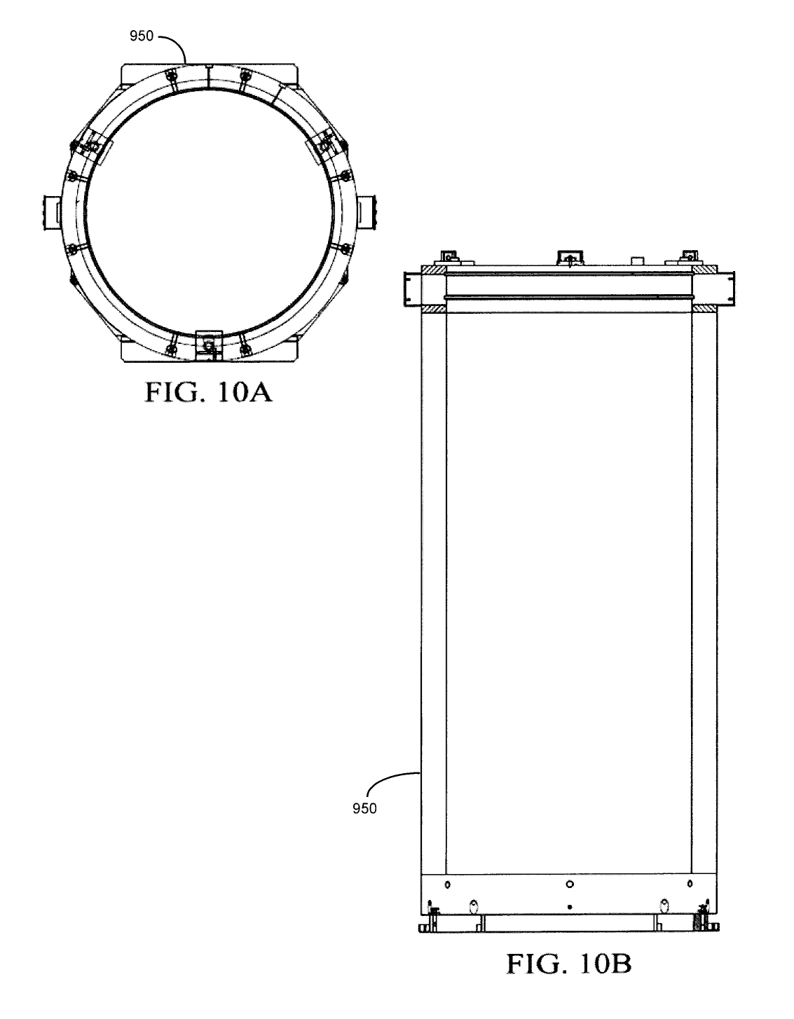

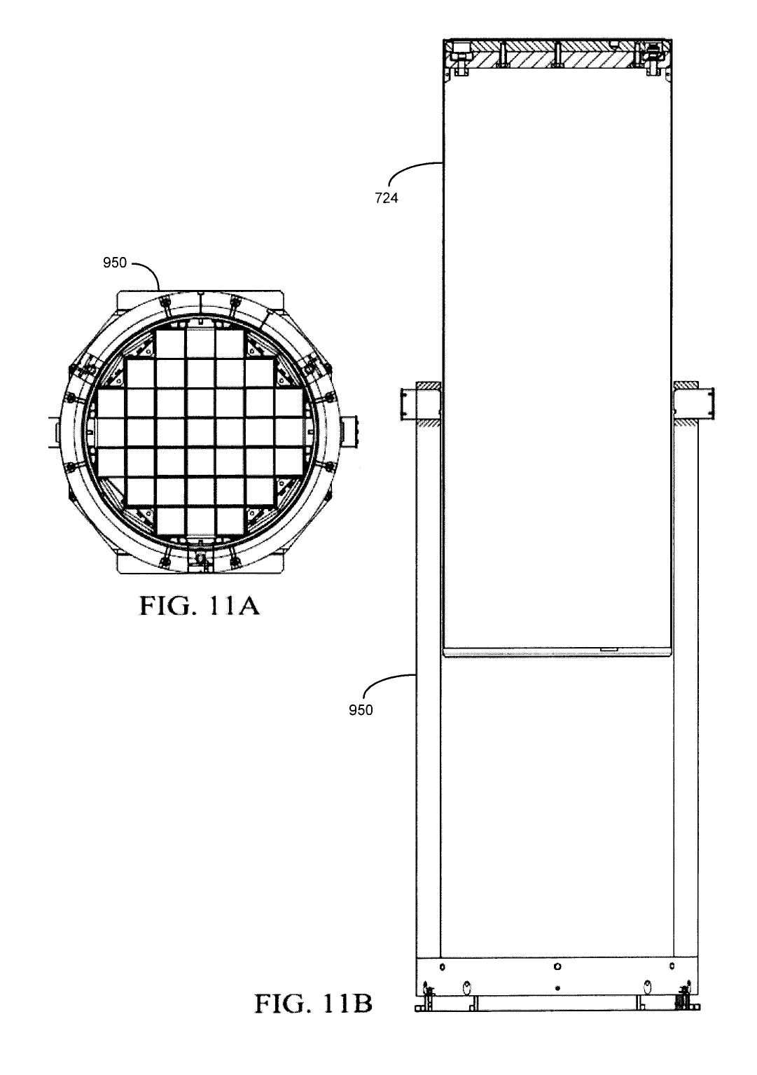

FIGS. 10A-10B depict a transfer cask 950 employed in various embodiments of the disclosure. A spent fuel canister containing a spent fuel basket that in turn contains spent nuclear fuel assemblies or tubes containing spent nuclear fuel assemblies can be inserted in the transfer cask 950. The depicted transfer cask 950 can be one that is associated with a dry storage system. The transfer cask 950 can be configured to transfer a spent fuel canister with a spent fuel basket having spent fuel assemblies disposed therein into a storage cask associated with a dry storage system, or, alternatively, into a transport cask. Accordingly, a dry storage cask or a dual-purpose dry storage and transport cask can be employed in accordance with embodiments of the disclosure, and the depicted transfer cask 950 can transfer a spent fuel canister to either type of cask. Such a transport or storage cask can also be constructed of concrete, metal or other materials and combinations thereof that provide structural integrity for transport or storage of spent nuclear fuel as well as radioactive shielding. Accordingly, FIGS. 11A and 11B depict insertion of a spent fuel canister 724 into a transfer cask 950 according to embodiments of the disclosure. The step of insertion of the spent fuel canister 724 into a transfer cask 950 can be performed in a transfer area of a spent nuclear fuel pool. Accordingly, the spent fuel canister 724 can then be transferred via the transfer cask 950 to a transport cask or storage cask associated with a dry storage system. In one embodiment, the transfer cask 950 containing the spent fuel canister 724 and spent fuel basket with spent fuel assemblies disposed therein can be removed from a transfer area of a spent nuclear fuel pool, and subsequently transfer the spent fuel canister 724 into a transport cask or storage cask associated with a dry storage system external to the spent nuclear fuel pool. Thereafter, the storage cask can be sealed and placed in an on-site storage area. In the case of a transport cask, the transport cask can be sealed as well as transported and placed in an off-site dry storage facility or other repository.

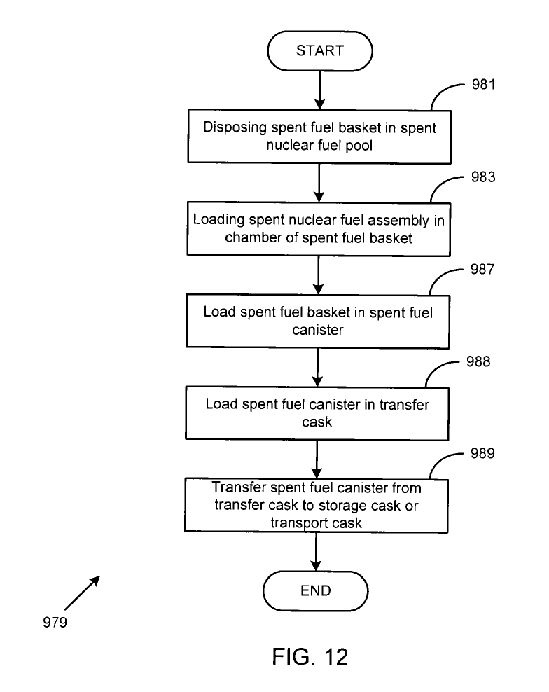

With reference to FIG. 12, shown is a flowchart that provides one example of a method 979 of various embodiments of the present disclosure. It is understood that the flowchart of FIG. 12 merely provides examples of the many different types of functional arrangements that may be employed to implement the operation of the methods as described herein. To begin, in box 981, a spent fuel basket is disposed in a spent fuel pool. As described above, a spent fuel basket according to embodiments of the disclosure can be disposed in a spent fuel pool equipped with a superstructure configured to provide structural support to the spent fuel baskets. In box 983, a spent fuel assembly is loaded in a chamber of the spent fuel basket. As also described herein, a spent fuel basket according to embodiments of the disclosure can contain a plurality of chambers in which spent fuel assemblies and/or tubes containing a spent fuel assembly can be loaded. In box 987, the spent fuel basket can be loaded into a spent fuel canister. In box 988, the spent fuel canister containing the spent fuel basket and fuel assemblies can be loaded into a transfer cask. The spent fuel canister can be loaded into the transfer cask in a transfer area of a spent nuclear fuel pool. In box 989, the spent fuel canister can be transferred from the transfer cask into a transport cask or storage cask associated with a dry storage system.

Although the flowchart of FIG. 12 shows a specific order of execution, it is understood that the order of execution may differ from that which is depicted. For example, the order of execution of two or more blocks may be scrambled relative to the order shown. Also, two or more blocks shown in succession in FIG. 12 may be executed concurrently or with partial concurrence. Further, in some embodiments, one or more of the blocks shown in FIG. 12 may be skipped or omitted.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A system, comprising:
means for immersing a plurality of spent nuclear fuel assembles;
means for containing the plurality of spent nuclear fuel assemblies;
means for securing the containing means in the immersing means;
means for lifting the containing means; and
means for inserting the containing means in a transport means.

2. A system, comprising:
a spent nuclear fuel pool;
a superstructure in the spent nuclear fuel pool, the superstructure having at least one supporting structure; and
at least one spent fuel basket, the at least one spent fuel basket having a plurality of chambers, each of the chambers adapted to store a spent nuclear fuel assembly, the at least one spent fuel basket further configured to be received by at least one of a spent fuel canister and a transfer cask; wherein
the at least one supporting structure of the superstructure is configured to accept the at least one spent fuel basket.

3. The system of claim 2, wherein the at least one spent fuel basket is a dry storage spent fuel basket configured to receive a plurality of spent fuel assemblies.

4. The system of claim 2, wherein the at least one spent fuel basket further comprises a spent fuel transport basket configured to receive a plurality of spent fuel assemblies, the spent fuel transport basket further configured to be stored in a dry storage cask.

5. The system of claim 2, wherein the at least one supporting structure is configured to restrict movement of the at least one spent fuel basket within the spent nuclear fuel pool.

6. The system of claim 2, wherein the at least one spent fuel basket further comprises at least one lifting lug, the at least one lifting lug configured to facilitate lifting of the at least one spent fuel basket and a plurality of spent fuel assemblies.

7. The system of claim 2, further comprising:
at least one spent fuel canister configured to receive the at least one spent fuel basket; and
at least one spent fuel canister closure lid configured to seal the at least one spent fuel canister.

8. The system of claim 7, further comprising:
at least one transport cask configured to receive the at least one spent fuel canister; and
at least one transport cask closure lid configured to seal the at least one transport cask.

9. A method for storing spent nuclear fuel, comprising the steps of:
disposing a spent fuel basket in a spent nuclear fuel pool;
loading at least one spent nuclear fuel assembly in at least one chamber of a spent fuel basket, the spent fuel basket having a plurality of chambers, each of the chambers adapted to receive a spent nuclear fuel assembly;
loading the spent fuel basket in a spent fuel canister; and
loading the spent fuel canister in at least one of a storage cask and a transport cask.

10. The method of claim 9, wherein the step of loading the spent fuel canister in at least one of the storage cask and a transport cask further comprises the steps of:
loading the spent fuel canister in a transfer cask; and
transferring the spent fuel canister from the transfer cask to at least one of the storage cask and the transport cask.

11. The method of claim 9, further comprising the step of securing the spent fuel basket to at least one adjacent spent fuel basket.

12. The method of claim 9, further comprising the step of securing a plurality of spent fuel baskets in the spent nuclear fuel pool with a spent nuclear fuel pool superstructure, the spent nuclear fuel superstructure configured to restrict movement of the spent fuel baskets.

13. The method of claim 9, wherein the spent fuel basket further comprises a dry storage spent fuel basket configured to receive a plurality of spent fuel assemblies.

14. The method of claim 9, wherein the spent fuel is configured to receive a plurality of spent fuel assemblies, the spent fuel transport basket further configured to be stored in a dry storage cask.

15. The method of claim 9, wherein the storage cask is a spent fuel dry storage cask.

16. The method of claim 9, further comprising the step of sealing the spent fuel canister with a canister closure lid.

17. The method of claim 9, wherein the step of loading the spent fuel basket in a spent fuel canister further comprises the step of lowering the spent fuel canister in a loading area associated with the spent fuel pool.

18. The method of claim 17, wherein the step of loading the spent fuel basket in a spent fuel canister further comprises the steps of:
securing the spent fuel basket by at least one lifting lug coupled to the spent fuel basket, the at least one lifting lug configured to facilitate lifting of the spent fuel basket; and
lifting the spent fuel basket within the spent fuel pool; and
inserting the spent fuel basket into the spent fuel canister.

19. The method of claim 18, further comprising the step of sealing the at least one of the storage cask and the transport cask with a cask closure lid.

20. The method of claim 19, further comprising the step of transporting the sealed transport cask to a dry storage facility.

21. The method of claim 9, further comprising the step of replacing the removed spent fuel basket with a second spent fuel basket.
